(19) United States
(12) Patent Application Publication
(10) Pub. No.: US 2017/0349036 A1
(43) Pub. Date: Dec. 7, 2017

(54) KOJO MBIR AUTOMOBILE FRONT VISOR

(71) Applicant: Charles Codman Blankson, Fontana, CA (US)

(72) Inventor: Charles Codman Blankson, Fontana, CA (US)

(21) Appl. No.: 15/173,503

(22) Filed: Jun. 3, 2016

(51) Int. Cl. B60J 3/02

(52) U.S. Cl. CPC B60J 3/0208; B60J 3/026

(57) ABSTRACT

This device is a sun visor for vehicles. The device consists of the visor body and a pivot mount. The device is attached to the interior roof and rotates down and sideways. The device has two inside panels with one panel extending towards the back of the vehicle and the other flipped down. The inside panels provide the driver and the front seat passenger additional protection from the sun's heat.

The device comes in two configurations. The first is attached to the front of the vehicle directly in front of the vehicle driver. The second configuration is attached to the front of the vehicle directly in front of the front seat passenger. The driver side visor has two inside panels. The passenger side visor also has two inside panels. The driver side visor can be flipped down from the interior roof of the vehicle and rotated to the left side to cover the upper part of the driver door window. After rotation, the two panels can be pulled from the visor, one at a time, with the second panel opening down from the first panel.

Correspondingly, the passenger side visor can be flipped down from the roof of the vehicle and rotated to the right side to cover the upper part of the passenger door window. After rotation, the two panels can be pulled from the visor, one at a time, with the second panel opening down from the first panel.

The fully extended panels provide extra protection to the driver and the front seat passenger from the sun's heat. The device is mounted in the front of the vehicle as in conventional vehicle visors.

### BACKGROUND OF THE INVENTION

The current sun visors in automobiles work well to shade and protect the driver as well as the front seat passenger from the sun's glare and heat when the vehicle is being driven in the direction of the sun. However, the visors don't offer complete protection to the driver or the front seat passenger when the sun's heat is coming from either side of the vehicle through the side windows. Although the two current front visors commonly found in automobile vehicles today can be rotated downwards or sideways to cover part of the side windows, and many of these front visors have panels that can be pulled out towards the back of the vehicle to provide more protection, the extended visors do not cover the entire upper part of the side windows, especially close to the nook. The extended panels do not cover the top left nook at the corner of the driver side door or the top right nook at the corner of the passenger side door.

This invention is proposed to cover the top left nook at the corner of the driver side door and the top right nook at the corner of the passenger side door.

### REFERENCES

Blankson, Charles Codman: U.S. Pat. No. 9,333,836
Marcus, Konrad H. et al: U.S. Pat. No. 8,714,621
Carsten Glaser, Muhltal: U.S. Pat. No. 8,100,459
Matheopoulos, Paul: U.S. Pat. No. 4,580,829
Gervasoni, Pascal: U.S. Pat. No. 5,626,381
Moo, Hing F.: U.S. Pat. No. 5,673,957
Riekse, Neil B: U.S. Pat. No. 6,290,280
Driscoll, Valerie: U.S. Pat. No. 6,981,733
Swain, Anthony T.: U.S. Pat. No. 7,121,672
Lee, Jae Woo: U.S. Pat. No. 7,188,886

### DESCRIPTION OF THE DRAWINGS

The proposed automobile visor is presented in the following diagrams:

FIG. 1: These are cross, side and top elevational views of the Driver Side Visor, Visor S, flipped down from the interior roof of the vehicle in front of the driver.

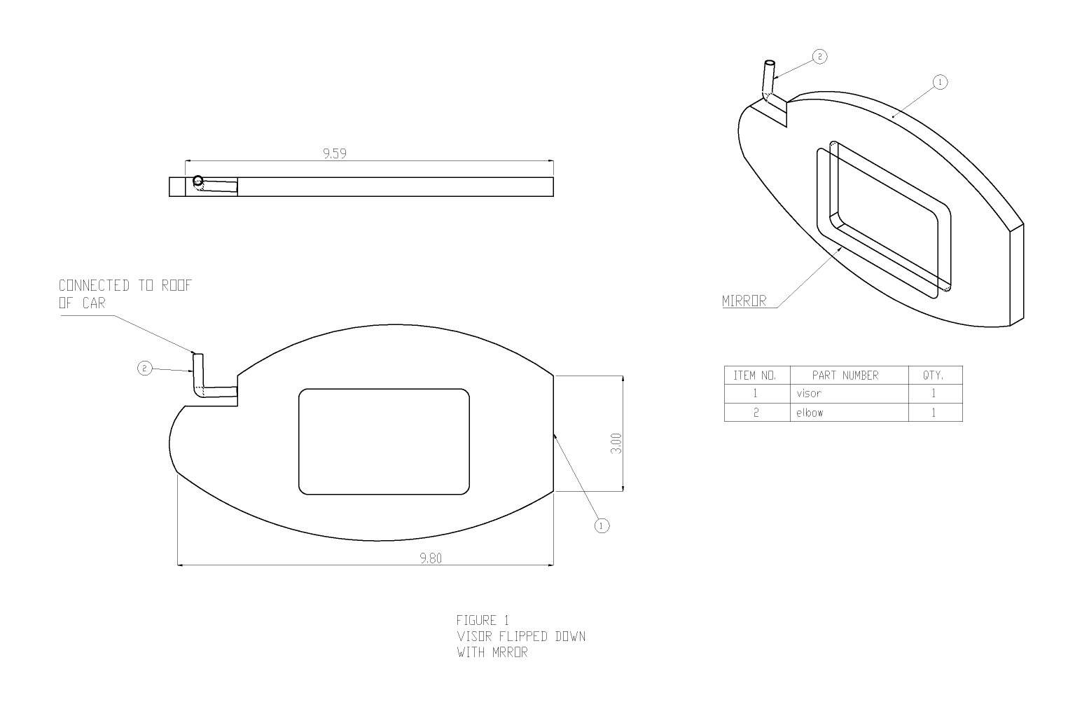

FIG. 2: These are cross, side and top elevational views of the Driver Side Visor, Visor S, rotated to the left of the driver to cover the upper part of the driver side door. The figure shows the side of the visor with the panels embedded in the visor.

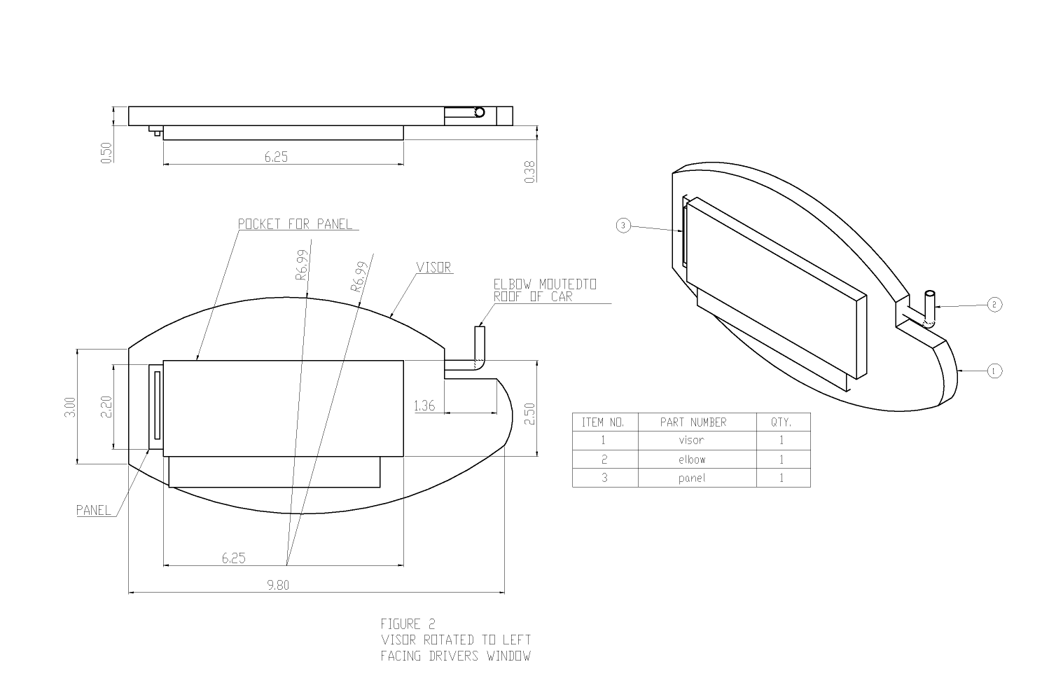

FIG. 3: These are cross, side and top elevational views of the Driver Side Visor, Visor S, with the two panels fully extended; one extending towards the back of the vehicle and the other flipped down.

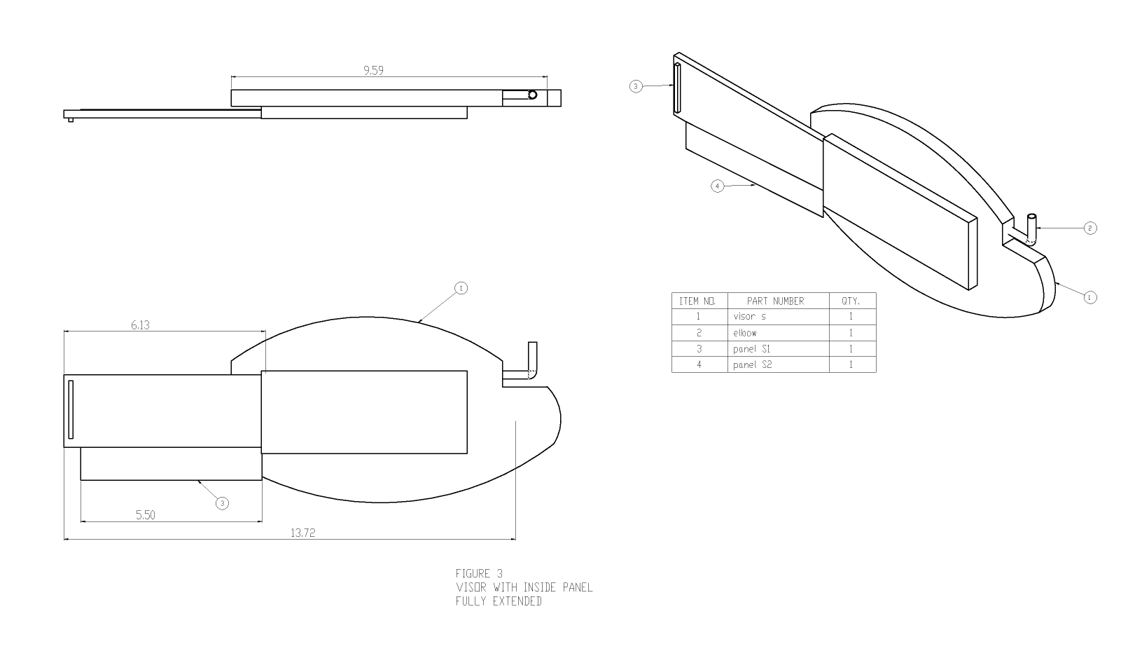

FIG. 4: These are cross, side and top elevational views of the Passenger Side Visor, Visor T, flipped down from the interior roof of the car in front of the front seat passenger.

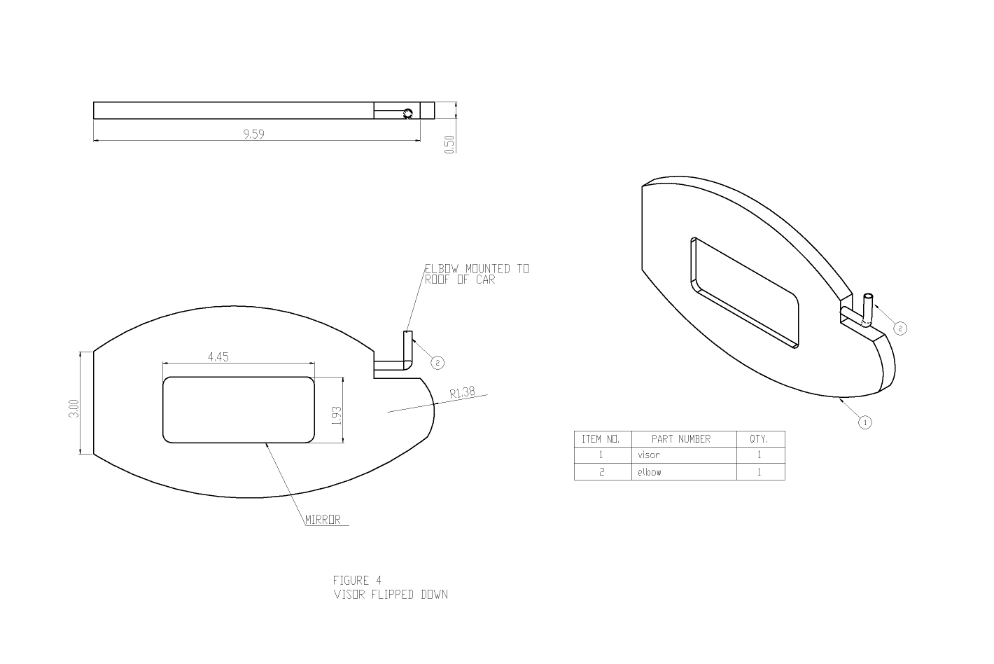

FIG. 5: These are cross, side and top elevational views of the Passenger Side Visor, Visor T, rotated to the right of the front seat passenger to cover the upper part of the passenger side door. The figure shows the side of the visor with the panels embedded in the visor.

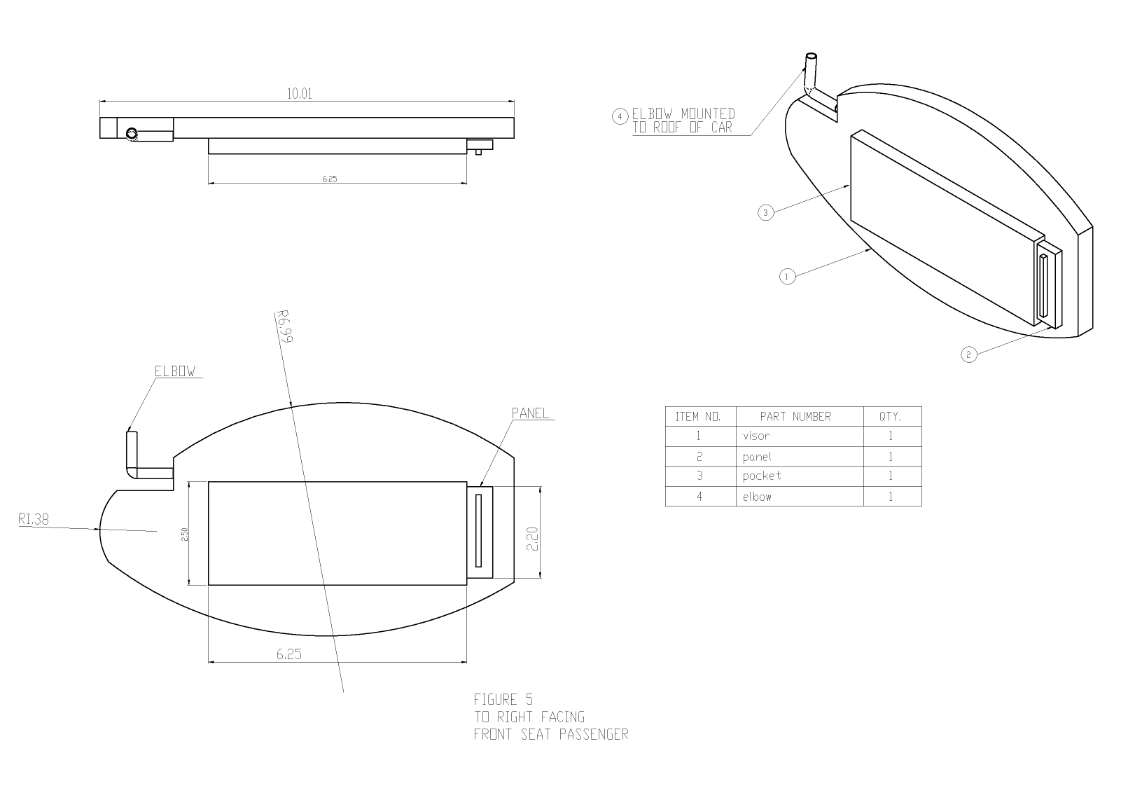

FIG. 6: These are cross, side and top elevational views of the Passenger Side Visor, Visor T, with the two panels fully extended; one extending towards the back of the vehicle and the other flipped down.

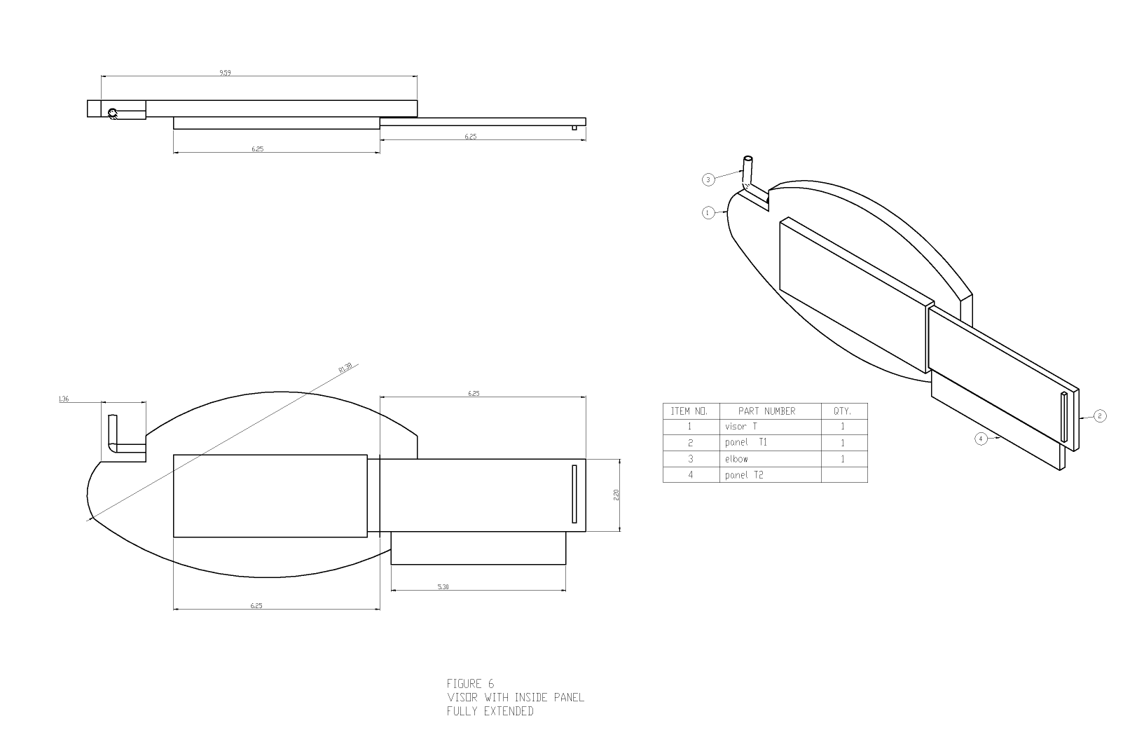

1. An automobile sun visor shield packet consists of a Driver Side Visor and a front seat Passenger Side Visor. The Driver Side Visor consists of a conventional visor hereafter referred to as Visor S. The Passenger Side Visor consists of a conventional visor hereafter referred to as Visor T. Both Visors S and T have openings on the back through which the panels extend. Each visor has two inside panels.

2. The two inside panels in Visor S in claim 1 are numbered S1 and S2. S1 is larger than S2. Fully extended, Panel S2 is a flap that opens down from Panel S1.

3. The two inside panels in Visor T in claim 1 are numbered T1 and T2. T1 is larger than T2. Fully extended, Panel T2 is a flap that opens down from Panel T1.
